(19) United States
(12) Patent Application Publication
(10) Pub. No.: US 2023/0036373 A1
(43) Pub. Date: Feb. 2, 2023

(54) Dynamic Performance-Based Skills Assessment

(71) Applicant: Google LLC, Mountain View, CA (US)

(72) Inventors: Harish Brahmsandra Dilip, San Jose, CA (US); Casey Palowitch, Cupertino, CA (US)

(21) Appl. No.: 17/963,639

(22) Filed: Oct. 11, 2022

Related U.S. Application Data
(60) Provisional application No. 63/342,858, filed on May 17, 2022.

(51) Int. Cl. G06Q 10/06

(52) U.S. Cl. CPC G06Q 10/06398

(57) ABSTRACT

This technology relates to dynamic performance-based skills assessment techniques or systems in which tasks are randomly assigned to users or candidates in real time. The system, for example, may be embodied in a software system in which a candidate or student performs a dynamically created set of hands-on activities that are evaluated in real-time against a scoring rubric. The hands-on activities require candidates to apply their skills and, in turn, allows the system to objectively measure a candidate's ability to accomplish real-world workplace tasks in a live environment.

### CROSS REFERENCE TO RELATED APPLICATIONS

The present application claims the benefit of the filing date of U.S. Provisional Patent Application No. 63/342,858, filed May 17, 2022, the disclosure of which is hereby incorporated herein by reference.

### BACKGROUND

Assessing technical skills and competencies is an increasingly important challenge for a world pressed to adopt current technologies to accomplish digital transformation. A recruiter determining the competency of a potential candidate for hire, or an individual attaining a certification to prove a skill to a future or current employer are just two high-demand examples of what has become a multi-billion dollar global industry. Examples of skill assessment methodologies include work sample testing, cognitive ability testing, personality testing, interviewing, or a combination of these. These methodologies typically rely on multiple choice tests chosen from a domain of technical knowledge. Some platforms may implement programming code syntax check for coders. One highly sought after skill assessments achievement includes branded industry certifications designed to physchometric standards and delivered in controlled environments. These certifications are, typically, however, based on multiple choice knowledge tests. Generally, these methodologies are static in nature and vulnerable to pre-test knowledge by a candidate, which may impact the reliability of test results.

### SUMMARY

Aspects of the disclosed technology are systems and methods or processes that provide techniques or methodologies for assessing performance. For example, an aspect of the disclosed technology may comprise a method for assessing performance, comprising storing, in a task bank, a plurality of performable tasks, generating a first set of tasks from the plurality of performable tasks, the first set of tasks comprising a plurality of first task elements organized in a first unique sequence, measuring a first user response in performing the first set of tasks, and outputting a first score associated with the first user response. In accordance with this aspect of the disclosed technology, the first set of tasks is generated by randomly selecting at least one of the plurality of first task elements while the first user is performing one or more of the plurality of first task elements.

In accordance with this aspect of the disclosed technology, generating is performed in a live computing environment. Further in accordance with this aspect of the disclosed technology, generating may comprise shuffling the plurality of performable tasks in real time to generate the first set of tasks while measuring the first user response. In accordance with an aspect of the disclosed technology real time may comprise, more generally, a delay between a user input and response by the computing environment that is not disruptive to the user, e.g., on the order of seconds. It may also include such a delay on the order of multiple clock cycles and may also include a system delay associated with information being communicated between a user and the computing environment.

Further in accordance with this aspect of the disclosed technology, the method comprises modifying the plurality of performable tasks stored in the task bank while the first user is performing the first set of tasks. In addition, generating may comprise executing a script containing logic for randomly selecting the first task elements.

Further in accordance with this aspect of the disclosed technology, the method may comprise generating a second set of tasks from the plurality of performable tasks, the second set of tasks comprising a plurality of second task elements organized in a second sequence, wherein the first set of tasks and second set of tasks are generated by randomly selecting the plurality of first task elements and the plurality of second task elements such that the pluralities of first and second task elements each include one or more different task elements and the first sequence is ordered differently than the second sequence. In accordance with this aspect of the technology, the method may comprise measuring a second user response in performing the second set of tasks and outputting a second score associated with the second user response. Further, the first set of tasks and second set of tasks are generated by randomly selecting one of the pluralities of first and second task elements while either the first user or the second user is performing, respectively, the first set of tasks or the second set of tasks such that the pluralities of first and second task elements each include one or more different task elements and the first sequence is ordered differently than the second sequence. Further still, generating comprises shuffling the plurality of performable tasks in real time to generate the second set of tasks while measuring the first user response or the second user response.

As another example, an aspect of the disclosed technology may comprise a system. The system may include a task bank storing a plurality of performable tasks; one or more computing devices; and a memory storing instructions that when executed by the one or more computing devices cause the one or more computing devices to: generate a first set of tasks from the plurality of performable tasks, the first set of tasks comprising a plurality of first task elements organized in a first unique sequence; measure a first user response in performing the first set of tasks; and output a first score associated with the first user response, and wherein the first set of tasks is generated by randomly selecting at least one of the plurality of first task elements while the first user is performing one or more of the plurality of first task elements.

In accordance with this aspect of the disclosed technology, the first set of tasks may be generated using one of a random number generator, a round-robin algorithm, or a weighted round-robin algorithm. In addition, the instructions are configured to generate the first set of tasks in a live computing environment.

Further in accordance with this aspect of the disclosed technology, the instructions to generate the first set of tasks cause the one or more computing devices to shuffle the plurality of performable tasks in real time to generate the first set of tasks while measuring the first user response. Further still, the instructions may cause the one or more computing devices to modify the plurality of performable tasks stored in the task bank while the first user is performing the first set of tasks.

In accordance with this aspect of the disclosed technology, the instructions to generate may cause the one or more computing devices to execute a script containing logic for randomly selecting the first task elements using one of a random number generator, a round-robin algorithm, or a weighted round-robin algorithm.

Further, the instructions may cause the one or more computing devices to generate a second set of tasks from the plurality of performable tasks, the second set of tasks comprising a plurality of second task elements organized in a second sequence, wherein the first set of tasks and second set of tasks are generated by randomly selecting the plurality of first task elements and the plurality of second task elements such that the pluralities of first and second task elements each include one or more different task elements and the first sequence is ordered differently than the second sequence. Further still, wherein the instructions may cause the one or more computing devices to measure a second user response in performing the second set of tasks and outputting a second score associated with the second user response. In addition, the first set of tasks and second set of tasks may be generated by randomly selecting one of the pluralities of first and second task elements while either the first user or the second user is performing, respectively, the first set of tasks or the second set of tasks such that the pluralities of first and second task elements each include one or more different task elements and the first sequence is ordered differently than the second sequence.

In addition, the instructions to generate the second set of tasks may cause the one or more computing devices shuffling the plurality of performable tasks in real time to generate the second set of tasks while measuring the first user response or the second user response.

### BRIEF DESCRIPTION OF THE DRAWINGS

FIG. 1 illustratively depicts an example swim lane flow diagram in accordance with an aspect of the disclosed technology.

FIG. 2 illustratively depicts an example swim lane flow diagram in accordance with an aspect of the disclosed technology.

FIG. 3 illustratively depicts an example software system diagram in accordance with an aspect of the disclosed technology.

FIG. 4 illustratively depicts an example system in accordance with an aspect of the disclosed technology.

FIG. 5 illustratively depicts an example system in accordance with an aspect of the disclosed technology.

### DETAILED DESCRIPTION

This technology relates to dynamic performance-based skills assessment techniques or systems in which tasks are randomly assigned to users or candidates in real time. The system, for example, may be embodied in a software system in which a candidate performs a dynamically created set of hands-on activities that are evaluated in real-time against a scoring rubric. The hands-on activities require candidates to apply their skills and, in turn, allows the system to objectively measure a candidate's ability to accomplish real-world workplace tasks in a live environment. As such, the system provides a technique to provide task oriented certifications and skills assessments.

A system that provides the same set of tasks to a candidate and/or provides tasks in the same order in each execution of an assessment may be vulnerable to creating secondary markets in which tasks and their solutions may be recorded and shared. As such, such systems are unable to accurately measure the performance of each individual candidate without a significant risk that a candidate may already know the tasks and their solution that form the assessment (e.g., cheating). In addition, such systems are inefficient in terms of content creation and their ability to maintain multiple permutations of tests (e.g., tasks are typically formed in deterministic sets).

This technology comprises a system that provides users with a dynamic set of tasks using a task bank as part of a performance-based assessment. This results in randomizing objectives across test executions. Specifically, each execution of an assessment causes a different set of tasks to be generated and/or tasks to be generated in different orders. Tasks are generated or selected dynamically in the sense that they are chosen while the user or candidate is responding or while the test is being performed. For example, a candidate may access the system from a client device via a catalog on Qwiklabs. In response to the user request, the system presents a set of hands-on activities (e.g., tasks) that are randomly selected from a backend task bank while the user is performing tasks. The tasks are selected based on parameters defined by a lab author to dynamically pick activities along with their corresponding assessment logic from the task bank. The lab author, for example, defines the performable tasks that are used to populate the task bank and the assessment logic that is used to determine when a task is completed (e.g., a pass score or certification criteria that needs to be met).

The system generally comprises a task bank, a logic for randomizing and choosing tasks from the task bank (e.g., task logic), and a logic for assessing tasks in the task bank (e.g., assessment logic). The system generally takes as input a given number of tasks and an assessment/performance logic. The tasks are then selected based on the task logic and provided as an ordered set that is different across different candidates. The performance logic is applied to the candidate's response to provide an assessment relative to a scoring rubric. The elements are coupled to a lab repository.

The task logic may take the form of a Python script that randomizes tasks from the task bank. The task bank may comprise a .json file that defines the bank of tasks and how they are split across multiple domains (e.g., networking, storage, computing).

This technology overcomes some of the inefficiencies associated with prior systems. For example, the technology addresses potential issues associated with candidates already knowing the solution for an assessment they will perform, since the system generates hands-on activities dynamically and the task bank is extendable to include a sufficient number of activities. The system also seamlessly applies the new logic without requiring a learning curve or causing a negative experience impact. This is the case because candidates perform the dynamically selected hands-on activities like they would have done earlier and are graded against the corresponding assessments related to the activities.

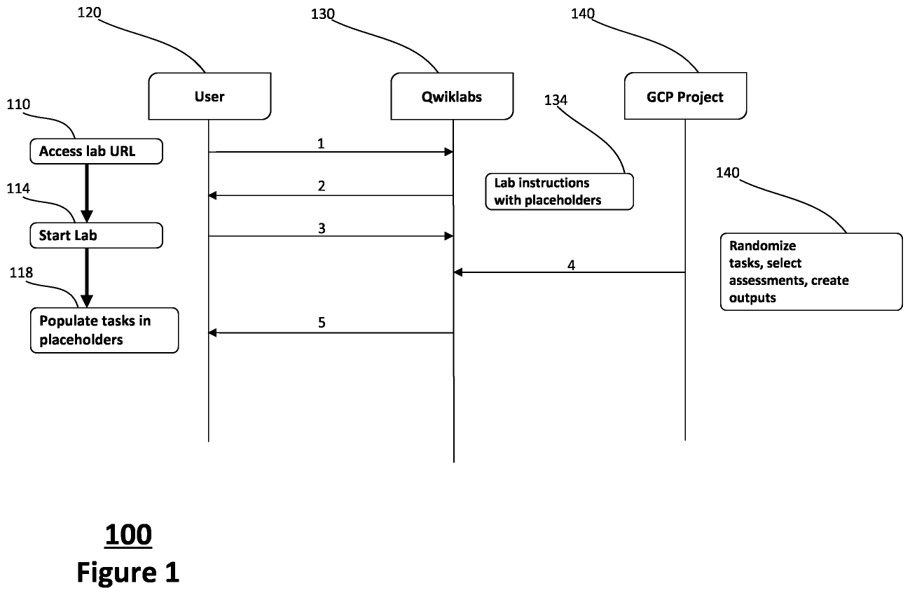

FIG. 1 illustrates a swim lane and/or process flow diagram 100 in accordance with an aspect of the disclosed technology. At a high level, the process flow is depicted by blocks 110, 114 and 118. At block 110, the process begins with selection of a URL that provides access to a performance-based application via a user interface. The selection may be made be made by user 120 clicking on a lab URL, e.g., block 110, that takes them to a web page running the application. For instance, the testing lab may comprise a test environment running on Google's Qwiklabs platform 130 in the form of Google Cloud Badges.

Next, the application allows the user to start the lab 114. Once the user starts the lab 114, the application then presents the user with randomly selected tasks that populate on-screen placeholder fields at block 118.

With respect to the swim lane view, the process takes place as follows. At step 1, user 120 accesses a performance-based assessment using a lab URL. In the specific embodiment shown, access comprises instantiation of a Qwiklabs 130 lab session, although any platform that provides a hands-on training environment suffices. At step 2, a testing or training platform (e.g., Qwiklabs) presents an instructions page to the user. The instruction page contains lab instructions with placeholders for activities in the lab 134. At step 3, the user 120 instantiates the lab session by, for instance, selecting a start lab button on the user screen.

At step 4, the testing or training platform 130 then operates to randomly select tasks along with their corresponding assessment logic, e.g., a scoring rubric. This operation may take place in a cloud-type environment such as, for example, via the Google Cloud Platform 140. More specifically, the operations of randomizing and selecting tasks, selecting corresponding assessment logic, and creating outputs that are then interacted with by the user 130, may done in a cloud-type environment where virtual machines are used to run instances of the lab instructions to different users who may be interfacing with the same test application simultaneously. In accordance with an aspect of the disclosed technology, the components of the system operate to dynamically select random activities and corresponding assessment logic, as illustrated at block 140, for output to individual users so as to mitigate against two users receiving the same order of tasks or the exact same tasks. As such, at step 5, the application populates the placeholders in a given user's lab instructions with dynamically selected tasks and evaluates their completion using a corresponding assessment logic.

The assessment logic may, for example, comprise rules that determine whether a user appropriately follows a series of instructions to create a web service or a virtual machine (VM). As the user carries out a given step as instructed, the assessment logic may then record whether the user performs the steps as required and determine a score that reflects the user's competency in creating the web service or VM.

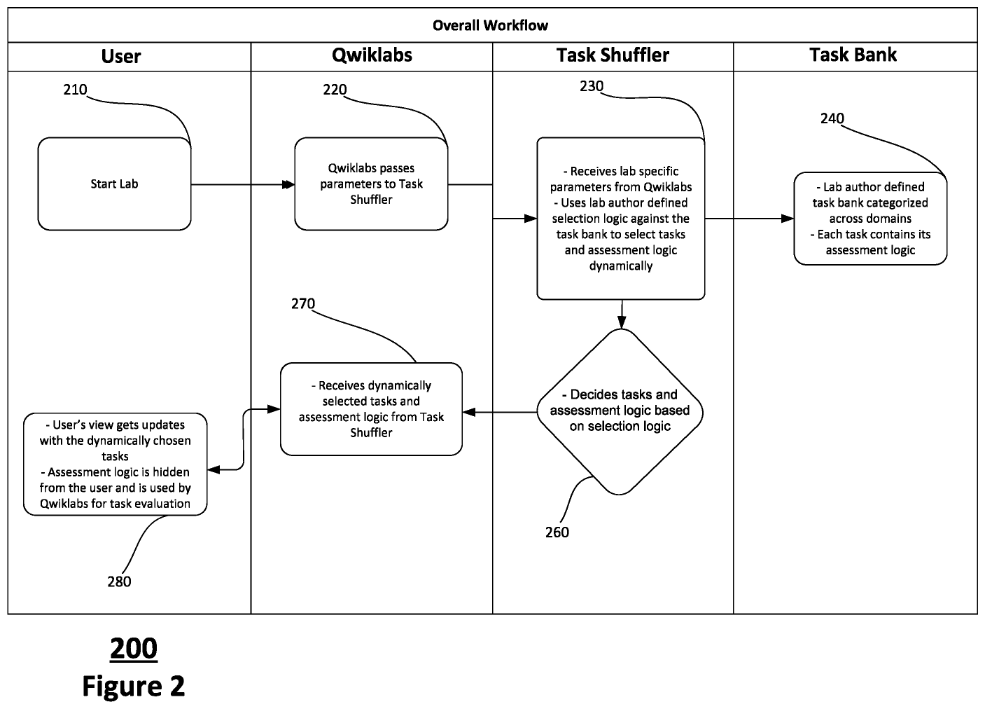

Turning now to FIG. 2, which illustrates an overall workflow diagram 200 in accordance with an aspect of the disclosure. The workflow or process 200 begins when a user starts a lab 210. In this example, the user is assumed to access the system from a client device via a catalog on Qwiklabs. In response to the user action, Qwiklabs passes parameters to a task shuffler at block 220. The parameters may comprise a number of domains, tasks per domains, etc. The parameters, as well as the domains, are provided by a lab author. For example, a lab author (e.g., the creator of the test/assessment) can define the tasks in the backend to be categorized under domains (or sections) and might want multiple tasks from each domain to be dynamically provided to the user on lab launch. For instance, the lab author can determine that the lab would be focusing on providing tasks under 3 domains—networking, storage, and compute—and categorize the backend tasks under the same. These parameters—number_of domains and tasks_per_domain—are configurable parameters that the lab author can leverage to indicate the values for the parameters. The backend repository stores the tasks as well as their corresponding assessment logic. When the lab is started by the user, the system built as part of the disclosed technology will typically obtain the actual values for the parameters—number_of domains and tasks_per_domain—and use them to dynamically (using a randomizing logic) select the required number of domains and associated tasks with their assessment logic and present them back to the lab user.

A task shuffler may then receive the lab specific parameters as shown at block 230. The task shuffler uses selection or task logic against the task bank to select tasks and assessment logic dynamically. The selection or task logic may be defined by the lab author. The task bank includes a collection of tasks categorized across domains, block 240. In addition, each task contains its assessment logic. As discussed, the tasks are defined by the lab author. The tasks may be compiled in the task bank in, for example, a tasks.json file by categorizing them across a list of domains.

The task shuffler also selects the tasks and assessment logic based on a selection or task logic at block 260. Specifically, as previously discussed, the system receives the parameters and configured parameter values. A script (e.g., a Python script) uses the values and reads the tasks.json file. The script then dynamically selects tasks based on the provided parameters. Dynamic selection may comprise randomly selecting tasks using one of a random number generator, a round-robin algorithm, or a weighted round-robin algorithm. The relevant randomization logic may be implemented by the lab author using the Python script.

Qwiklabs then receives the dynamically selected tasks and assessment logic from the task shuffler and passes them seamlessly to the user at block 270. The selected tasks are then rendered on the user's lab page at block 280. Specifically, the user's view is updated dynamically with the chosen tasks. The assessment logic is not detectable by the user and is used by Qwiklabs or similar platform for task evaluation.

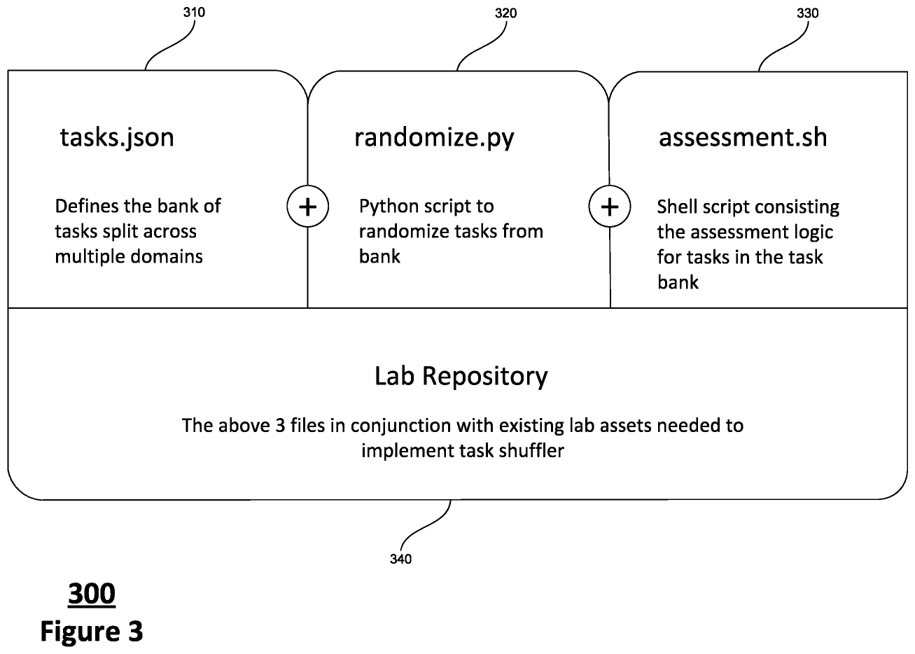

FIG. 3 shows a software system architecture 300 in accordance with an aspect of the disclosure. The functions of the different components or elements 310, 320, 330 and 340 are configured and interoperate as described above. As shown, component 310 comprises the tasks.json file, which defines the bank of tasks split across multiple domains. Component 320 comprises the script, which is shown as written in Python but is not limited to that particular language. Component 330 comprises the assessment logic which may be written as a shell or other script. The laboratory component 340 comprises components 310, 320, and 330 and other lab assets to implement the task shuffler.

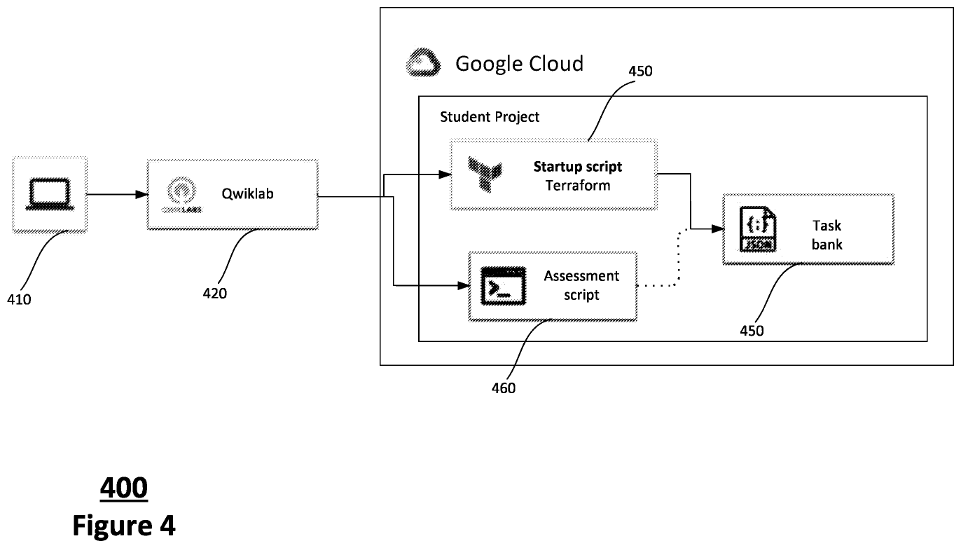

FIG. 4 illustratively depicts an example system 400 in accordance with an aspect of the present invention. The system includes a client device 410 that accesses Qwiklabs lab session 420 instantiated in a cloud environment 430. The example cloud environment is shown as the Google Cloud Platform, but any cloud platform may suffice and the user facing environment need not be implemented as a Qwiklabs session. As shown, the system includes a startup script 440, a task bank 450 and an assessment script 460. The startup script 440 may comprise the script for randomly selecting tasks from task bank 450, as well as other processes needed to receive input from the client device 410, provide information to the Qwiklabs modules, and generate output destined from the client device. The task bank 450 is configured as described previously. The assessment script may comprise the assessment scripts describe previously.

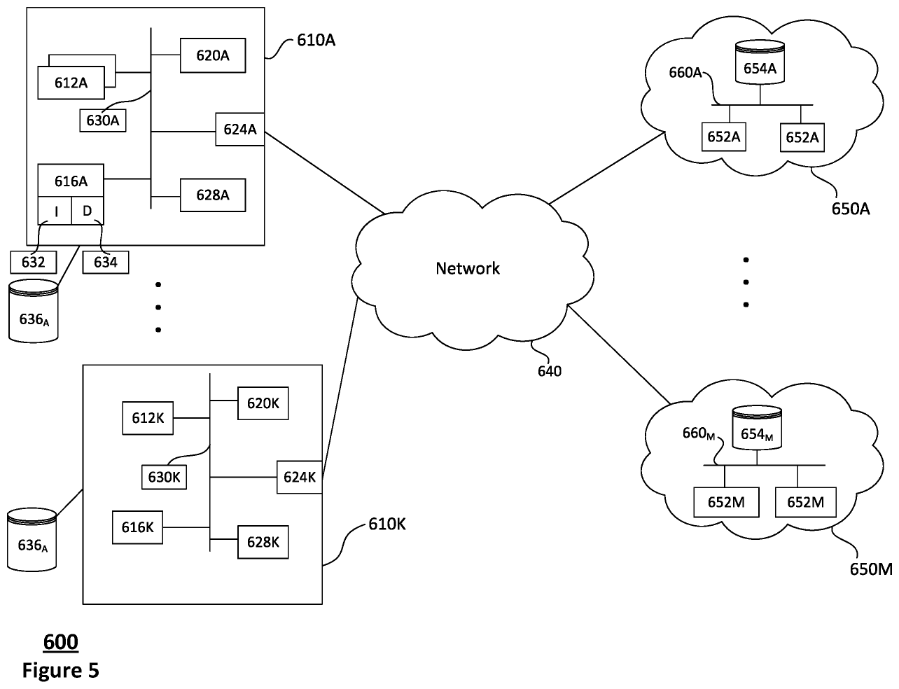

FIG. 5 is a block diagram of an example cloud system 600, in accordance with aspects of the disclosure. System 600 includes one or more computing devices 610A-K, including devices 610A, K and optionally one or more other devices (not shown). In some implementations, the system 600 includes a single computing device 610A which operates as host machine 300. The system 600 also includes a network 640 and one or more cloud computing systems 650A-M, which can include cloud computing systems 650A and 650M and optionally one or more other cloud computing systems (not shown). In some implementations, the system 600 includes a single cloud computing system 650A. Computing devices 610A-K may include computing devices located at customer locations that make use of cloud computing services. For example, if the computing devices 610A-K are located at a business enterprise, computing devices 610A-K may use cloud systems 650A-M as part of one or more services that provide software or other applications to the computing devices 610A-K.

As shown in FIG. 5, the computer devices 610A-K may respectively include one or more processors 612A-K, memory 616A-K storing data (D) 634A-K and instructions (I) 632A-K, displays 620A-K, communication interfaces 624A-K, and input systems 628A-K, which are shown as interconnected through network 630A-K. Each computing device 610A-K can be coupled or connected to respective storage devices 636A-K, which may include local or remote storage, e.g., on a Storage Area Network (SAN), that stores data.

Each computing device 610A-K may include a standalone computer (e.g., desktop or laptop) or a server. More generally, computing devices 610A-K may comprise a client device, a server, or a host device. The network 640 may include data buses, etc., internal to a computing device, and/or may include one or more of a local area network, virtual private network, wide area network, or other types of networks described below in relation to network 640. Memory 616A-K stores information accessible by the one or more processors 612A-K, including instructions 632A-K and data 634A-K that may be executed or otherwise used by the processor(s) 612A-K. The memory 616A-K may be of any type capable of storing information accessible by a respective processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 632A-K may be any set of instructions to be executed directly (such as machine code) or indirectly (such as scripts) by the processor. One or more instructions executed by the processors can represent an operation performed by the processor. For example, the instructions may be stored as computing device code on the computing device-readable medium. In that regard, the terms “instructions,” “routines,” and “programs” may be used interchangeably herein, which are executed by the processor to perform corresponding operations. The instructions may be stored in object code format for direct processing by the processor, or in any other computing device language including scripts or collections of independent source code modules that are interpreted on demand or compiled in advance.

The data 634A-K may be retrieved, stored, or modified by processor(s) 612A-K in accordance with the instructions 632A-K. As an example, data 634A-K associated with memory 616A-K may include data used in supporting services for one or more client devices, an application, etc. Such data may include data to support hosting web-based applications, file share services, communication services, gaming, sharing video or audio files, or any other network based services.

Each processor 612A-K may be any of any combination of general-purpose and/or specialized processors. The processors 612A-K are configured to implement a machine-check architecture or other mechanism for identifying memory errors and reporting the memory errors to a host kernel. An example of a general-purpose processor includes a CPU. Alternatively, the one or more processors may be a dedicated device such as a FPGA or ASIC, including a tensor processing unit (TPU). Although FIG. 5 functionally illustrates the processor, memory, and other elements of each computing device 610A-K as being within a single block, it will be understood by those of ordinary skill in the art that the processor, computing device, or memory may actually include multiple processors, computing devices, or memories that may or may not be located or stored within the same physical housing. In one example, one or more of the computing devices 610A-K may include one or more server computing devices having a plurality of computing devices, e.g., a load-balanced server farm, that exchange information with different nodes of a network for the purpose of receiving, processing, and transmitting the data to and from other computing devices as part of customer's business operation.

Computing devices 610A-K may include displays 620A-K, e.g., monitors having a screen, a touch-screen, a projector, a television, or other device that is operable to display information. The displays 620A-K can provide a user interface that allows for controlling the computing device 610A-K and accessing user space applications and/or data associated VMs supported in one or more cloud systems 650A-M, e.g., on a host in a cloud system. Such control may include, for example, using a computing device to cause data to be uploaded through input system 628A-K to cloud systems 650A-M for processing, cause accumulation of data on storage 636A-K, or more generally, manage different aspects of a customer's computing system. In some examples, computing devices 610A-K may also access an API that allow them to specify workloads or jobs that run on Virtual Machines (VMs) in the cloud as part of IaaS (Infrastructure-as-a-System) or SaaS (Service-as-a-System). While input systems 628A-K may be used to upload data, e.g., a USB port, computing devices 610A-K may also include a mouse, keyboard, touchscreen, or microphone that can be used to receive commands and/or data.

The network 640 may include various configurations and protocols including short-range communication protocols such as Bluetooth™, Bluetooth™ LE, the Internet, World Wide Web, intranets, virtual private networks, wide area networks, local networks, private networks using communication protocols proprietary to one or more companies, Ethernet, Wi-Fi, HTTP, etc., and various combinations of the foregoing. Such communication may be facilitated by any device capable of transmitting data to and from other computing devices, such as modems and wireless interfaces. Computing devices 610A-K can interface with the network 640 through communication interfaces 624A-K, which may include the hardware, drivers, and software necessary to support a given communications protocol.

Network 640 may also implement network slicing. Network slicing supports customizing the capacity and capabilities of a network for different services such as connected home, video/audio streaming (buffered or real-time), geolocation and route planning, sensor monitoring, computer vision, vehicular communication, etc. Edge data center processing and local data center processing augments central data center processing to allocate 5G, 6G, and future network resources to enable smartphones, AR/VR/XR units, home entertainment systems, industrial sensors, cars and other vehicles, and other wirelessly-connected devices. Not only can terrestrial network equipment support connected home, video/audio streaming (buffered or real-time), geolocation and route planning, sensor monitoring, computer vision, vehicular communication, etc., non-terrestrial network equipment can enable 5G, 6G, and future wireless communications in additional environments such as marine, rural, and other locations that experience inadequate base station coverage. As support for computer vision, objects counting, intrusion detection, motion detection, traffic monitoring, health monitoring, device or target localization, pedestrian avoidance, AR/VR/XR experiences, enhanced autonomous/terrestrial objects navigation, and ultra high-definition environment imaging, etc., 5G, 6G, and future wireless networks enable fine range sensing and sub-meter precision localization. Leveraging massive bandwidths and wireless resource (time, frequency, space) sharing, these wireless networks enable simultaneous communications and sensing capabilities to support radar applications in smart displays, smartphones, AR/VR/XR units, smart speakers, industrial sensors, cars and other vehicles, and other wirelessly-connected devices.

Cloud computing systems 650A-M may include one or more data centers that may be linked via high speed communications or computing networks. A data center may include dedicated space within a building that houses computing systems and their associated components, e.g., storage systems and communication systems. Typically, a data center will include racks of communication equipment, servers/hosts, and disks. The servers/hosts and disks comprise physical computing resources that are used to provide virtual computing resources such as VMs. To the extent a given cloud computing system includes more than one data center, those data centers may be at different geographic locations within relatively close proximity to each other, chosen to deliver services in a timely and economically efficient manner, as well as to provide redundancy and maintain high availability. Similarly, different cloud computing systems are typically provided at different geographic locations.

As shown in FIG. 5, computing systems 650A-M may include host machines 652A-M, storage 654A-M, and infrastructure 660.A-M Host machines 652A-M may comprise host machine 300. Infrastructure 660A-M may include one or more switches (e.g., top of rack switches (TROs)), physical links (e.g., fiber), and other equipment used to interconnect host machines within a data center with storage 654A-M. Storage 654A-M may include a disk or other storage device that is partitionable to provide physical or virtual storage to virtual machines running on processing devices within a data center. Storage 654A-M may be provided as a SAN within the datacenter hosting the virtual machines supported by storage 654A-M or in a different data center that does not share a physical location with the virtual machines it supports. One or more hosts or other computer systems within a given data center may be configured to act as a supervisory agent or hypervisor in creating and managing virtual machines associated with one or more host machines in a given data center. In general, a host or computer system configured to function as a hypervisor will contain the instructions necessary to, for example, manage the operations that result from providing IaaS, PaaS (Platform-as-a-Service), or SaaS to customers or users as a result of requests for services originating at, for example, computing devices 610A-K.

In accordance with an aspect of the disclosed technology, any one of the computing devices 610A-K may comprise the client device discussed above in relation to FIG. 4, while another computing device of 610A-K may comprise an edge server through which the client device accesses any one of cloud computing systems 650A-M.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for assessing performance, comprising:
storing, in a task bank, a plurality of performable tasks;
generating a first set of tasks from the plurality of performable tasks, the first set of tasks comprising a plurality of first task elements organized in a first sequence;
measuring a first user response of a first user in performing the first set of tasks; and
outputting a first score associated with the first user response, and
wherein the first set of tasks is generated by randomly selecting at least one of the plurality of first task elements while the first user is performing one or more of the plurality of first task elements.

2. The method of claim 1, wherein generating is performed in a live computing environment.

3. The method of claim 1, wherein generating comprises shuffling the plurality of performable tasks in real time to generate the first set of tasks while measuring the first user response.

4. The method of claim 1, comprising modifying the plurality of performable tasks stored in the task bank while the first user is performing the first set of tasks.

5. The method of claim 1, wherein generating the first set of tasks comprises executing a script containing logic for randomly selecting the first task elements using one of a random number generator, a round-robin algorithm, or a weighted round-robin algorithm.

6. The method of claim 1, comprising generating a second set of tasks from the plurality of performable tasks, the second set of tasks comprising a plurality of second task elements organized in a second sequence, wherein the first set of tasks and second set of tasks are generated by randomly selecting the plurality of first task elements and the plurality of second task elements such that the pluralities of first and second task elements each include one or more different task elements and the first sequence is ordered differently than the second sequence.

7. The method of claim 6, comprising measuring a second user response in performing the second set of tasks and outputting a second score associated with the second user response.

8. The method of claim 7, wherein the first set of tasks and second set of tasks are generated by randomly selecting one of the pluralities of first and second task elements while either the first user or the second user is performing, respectively, the first set of tasks or the second set of tasks such that the pluralities of first and second task elements each include one or more different task elements and the first sequence is ordered differently than the second sequence.

9. The method of claim 8, wherein generating the second set of tasks comprises shuffling the plurality of performable tasks in real time to generate the second set of tasks while measuring the first user response or the second user response.

10. A system, comprising:
a task bank storing a plurality of performable tasks;
one or more computing devices; and
a memory storing instructions that when executed by the one or more computing devices cause the one or more computing devices to:
generate a first set of tasks from the plurality of performable tasks, the first set of tasks comprising a plurality of first task elements organized in a first sequence,
measure a first user response of a first user in performing the first set of tasks, and
output a first score associated with the first user response, and
wherein the first set of tasks is generated by randomly selecting at least one of the plurality of first task elements while the first user is performing one or more of the plurality of first task elements.

11. The system of claim 10, wherein the first set of tasks are generated using one of a random number generator, a round-robin algorithm or a weighted round-robin algorithm.

12. The system of claim 10, wherein the instructions are configured to generate the first set of tasks in a live computing environment.

13. The system of claim 10, wherein the instructions to generate the first set of tasks cause the one or more computing devices to shuffle the plurality of performable tasks in real time to generate the first set of tasks while measuring the first user response.

14. The system of claim 10, wherein the instructions cause the one or more computing devices to modify the plurality of performable tasks stored in the task bank while the first user is performing the first set of tasks.

15. The system of claim 10, wherein the instructions to generate cause the one or more computing devices to execute a script containing logic for randomly selecting the first task elements using one of a random number generator, a round-robin algorithm or a weighted round-robin algorithm.

16. The system of claim 10, wherein the instructions cause the one or more computing devices to generate a second set of tasks from the plurality of performable tasks, the second set of tasks comprising a plurality of second task elements organized in a second sequence, wherein the first set of tasks and second set of tasks are generated by randomly selecting the plurality of first task elements and the plurality of second task elements such that the pluralities of first and second task elements each include one or more different task elements and the first sequence is ordered differently than the second sequence.

17. The system of claim 16, wherein the instructions cause the one or more computing devices to measure a second user response in performing the second set of tasks and outputting a second score associated with the second user response.

18. The system of claim 17, wherein the first set of tasks and second set of tasks are generated by randomly selecting one of the pluralities of first and second task elements while either the first user or the second user is performing, respectively, the first set of tasks or the second set of tasks such that the pluralities of first and second task elements each include one or more different task elements and the first sequence is ordered differently than the second sequence.

19. The system of claim 18, wherein the instructions to generate the second set of tasks cause the one or more computing devices shuffling the plurality of performable tasks in real time to generate the second set of tasks while measuring the first user response or the second user response.
